(19) United States
(12) Patent Application Publication
(10) Pub. No.: US 2010/0058456 A1
(43) Pub. Date: Mar. 4, 2010

(54) IDS Sensor Placement Using Attack Graphs

(76) Inventors: Sushil Jajodia, Oakton, VA (US); Steven E. Noel, Dale City, VA (US)

Correspondence Address: GEORGE MASON UNIVERSITY;OFFICE OF TECHNOLOGY TRANSFER, MSN 5G5, 4400 UNIVERSITY DRIVE, FAIRFAX, VA, 22030, US

(21) Appl. No.: 12/548,115

(22) Filed: Aug. 26, 2009

Related U.S. Application Data
(60) Provisional application No. 61/092,154, filed on Aug. 27, 2008.

(51) Int. Cl. G06F 15/16

(52) U.S. Cl. 726/11

(57) ABSTRACT

Embodiments of the present invention identify locations to deploy IDS sensor(s) within a network infrastructure and prioritize IDS alerts using attack graph analysis. An attack graph that describes exploitable vulnerability(ies) within a network infrastructure is aggregated into protection domains. Edge(s) that have exploit(s) between two protection domains are identified. Sets that contain edge(s) serviced by a common network traffic device are defined. Set(s) that collectively contain all of the edge(s) are selected. The common network traffic device(s) that service the selected sets are identified as the location(s) to deploy IDS sensor(s) within the network infrastructure.

### CROSS-REFERENCE TO RELATED APPLICATIONS

This application claims the benefit of U.S. Provisional Application No. 61/092,154, filed Aug. 27, 2008, entitled “Optimal IDS Sensor Placement and Alert Prioritization Using Attack Graphs,” which is hereby incorporated by reference in its entirety.

### STATEMENT REGARDING FEDERALLY SPONSORED RESEARCH OR DEVELOPMENT

This invention was made with government support under: FA8750-05-C-0212 awarded by Homeland Security Advanced Research Projects Agency; FA8750-06-C-0246 awarded by Air Force Research Laboratory; DTFAWA-04-P-00278/0001 awarded by Federal Aviation Administration. The government has certain rights in the invention.

### BACKGROUND

A variety of challenges make it inherently difficult to secure computer networks against attack. Vulnerabilities in software design, implementation, and configuration are commonplace, and even the Internet itself lacks security as an original design goal. Once a machine is connected to a network, its security concerns become highly dependent on vulnerabilities across the network. Attackers can use vulnerable machines as stepping stones to penetrate through a network and compromise critical systems.

An Intrusion Detection System (IDS) is software and/or hardware designed to detect unwanted attempts at accessing, manipulating, and/or disabling of computer systems, mainly through a network, such as the Internet. An intrusion detection system is used to detect malicious behaviors that can compromise the security of networked computer systems. An IDS may include:
Sensor(s) that are deployed at strategic locations in the network, which monitor traffic at the sensor location and generate security events upon detection of malicious behaviors;
A central engine that records events (e.g., in an database) logged by the sensors; and
Console(s) to monitor events and control the sensors.

In some IDS implementations, all three components are combined in a single device or appliance. In a true distributed system, numerous sensors are deployed at various points in the network, which communicate over secure channels to the central engine. Multiple consoles may then interact with the central engine.

In network-based intrusion detection systems (NIDS), sensors are located at monitoring points in a network. Traditionally, sensors may be placed at network borders or in a network “demilitarized zone” (DMZ), with the assumption that attacks are launched from outside the network to be defended. The sensor monitors network traffic at its point of deployment and analyzes the traffic content for patterns of malicious behavior.

NIDS are usually deployed as an independent hardware/software platform, co-located with a network device that mediates traffic in a network. For example, using the open-source Snort NIDS developed by Sourcefire, Inc. of Columbia, Md., one can deploy numerous sensors as part of a distributed system. This involves configuring each Snort sensor to log detection events to a database on another host, and configuring the central Snort server to allow connections to its database and grant appropriate permissions to its database tables. One may also need to maintain time synchronicity between all sensors and the central server database, as well as ensure security of sensor-server communications. There may also be a need to configure the server to maintain different detection rule sets based on sensor location, since different parts of the network may have different security requirements. For larger networks, an even more distributed architecture separates the central server further, with a web server for IDS consoles on one machine and the database server on another machine.

A commercial version of the Snort technology exists as well, offered by Sourcefire. For this commercial offering, there is a charge for each IDS sensor deployed. Further, NIDS such as Snort are capable of mitigating attacks by applying network access controls such as firewall rules or terminating offending connections. Traditionally, through overly restrictive attack responses, this runs the risk of erroneously blocking legitimate network use (e.g., by spoofed “attack” packets).

There are other IDSs available, such as Cisco Secure IDS, Check Point RealSecure (available from Check Point Software Technologies Inc. of Redwood City, Calif.), and IBM RealSecure (available from International Business Machines Corp. of Armonk, N.Y.).

In traditional network defense, IDS sensors are often placed at network perimeters, and configured to detect every attempt at intrusion. But if an attacker manages to avoid detection at the perimeter, and gain a toehold into the network, attack traffic on the internal network is unseen at the perimeter. Also, in today's highly distributed grid computing, network boundaries are no longer clear.

Organizations have a desire to detect malicious traffic throughout their network, but may have limited resources for IDS sensor deployment. Moreover, IDS usually report all potentially malicious traffic, without regard to the actual network configuration, vulnerabilities, and mission impact. Given large volumes of network traffic, IDS with even small error rates can overwhelm operators with false alarms. Even when true intrusions are detected, the actual mission threat is often unclear, and operators are unsure as to what actions they should take.

Traditional tools for network vulnerability assessment simply scan individual machines on a network and report their known vulnerabilities. They give no clues as to how attackers might exploit combinations of vulnerabilities among multiple hosts to advance an attack on a network. It remains a labor-intensive and error-prone exercise for “connecting the dots” to predict vulnerability paths, and the number of possible vulnerability combinations to consider can be overwhelming. Consequently, it would be desirable to know the paths of vulnerability throughout a network, to reduce the impact of attacks.

Early work in automated construction of attack graphs applied symbolic model checking tools. But model checkers have significant scalability problems, a consequence of the exponential complexity of the general state space they consider. Early graph-based approaches for analyzing attack combinations suffered similar problems with state-space explosion.

Subsequently, scalable attack graph models have emerged. Rather than explicitly enumerating paths through state space, these models represent dependencies between state transitions (attacker exploits), eliminating path redundancies and succinctly capturing all state information. These models scale quadratically with the number of network hosts (ignoring man-in-the-middle attacks, which raise complexity to n³). By representing fully-connected portions of the attack graph (e.g., within a subnet) more efficiently, scalability is improved to linear within each defined portion.

Despite these advances, a key step has been overlooked. In particular, previous work does not address the placement of IDS sensors within the network infrastructure to cover known vulnerability paths. When IDS sensor placement is addressed in the literature, it is usually in the context of general architectures for distributed intrusion detection.

One implementation has been a model checker used to find a minimum coverage of attack paths, using IDS or other protection measures. This approach provides a weak kind of optimality, giving the minimum set of measures that block the attacker from the end goal (the unsafe state of the model checker), assuming that each such measure is successful. However, this is not a safe assumption, given the high likelihood of missed IDS detections. In other words, with such minimum coverage, if only one attack is missed, the remaining uncovered paths may readily allow network penetration to critical network assets. While such minimum coverage may be appropriate for assured hardening measures such as software patches and firewall rules, it is clearly insufficient for IDS deployment. Additionally, this approach does not identify how a minimum set of attack paths actually map to IDS sensor deployment in the network infrastructure. For example, an attack from host A to host B may pass through multiple network devices. But given all possible paths and network devices, the approach does not address on which physical device(s) on the network should the sensors be deployed. What is needed is a way to determine locations to optimally place intrusion detection system (IDS) sensors and use attack graph analysis to prioritize IDS alerts.

### BRIEF DESCRIPTION OF THE SEVERAL VIEWS OF THE DRAWINGS

FIG. 1 depicts a system diagram of a small network demonstrating the automated generation of attack graphs as per an aspect of an embodiment of the present invention.

FIG. 2 depicts flow diagram of a resulting attack graph demonstrating attacker threat detection, as per an aspect of an embodiment of the present invention.

FIG. 3 is a flow diagram of an attack graph demonstrating observation of dependency patterns among exploits, as per an aspect of an embodiment of the present invention.

FIG. 4 depicts flow diagram of an attack graph demonstrating regularities to be a natural choice for aggregating the attack graph into multiple levels of abstraction as per an aspect of an embodiment of the present invention.

FIG. 5 depicts a system diagram of an attack graph for an 8-machine testbed network demonstrating more advanced visualization capabilities, as per an aspect of an embodiment of the present invention.

FIG. 6 is a system diagram of a testbed network demonstrating a combination of real and replicated machine scans and attack graph implementation, as per an aspect of an embodiment of the present invention.

FIG. 7 depicts system diagram of a network demonstrating tracing routes of each subnet to subnet edge of an attack graph, as per an aspect of an embodiment of the present invention.

FIG. 8 depicts system diagram of an attack graph for testbed network demonstrating each graph edge to be a set of exploited vulnerabilities from one machine to another, as per an aspect of an embodiment of the present invention.

FIG. 9 depicts flow diagram for a computer readable storage medium demonstrating instructions that cause the processor to perform a method for identifying locations to deploy IDS Sensors within a network infrastructure, as per an aspect of an embodiment of the present invention.

FIG. 10 depicts system diagram of an IDS location deployment identification module demonstrating capability to identify locations to deploy IDS sensors within a network infrastructure, as per an aspect of an embodiment of the present invention.

### DETAILED DESCRIPTION OF EMBODIMENTS

Embodiments of the present invention locate the placement of intrusion detection system (IDS) sensors and prioritize IDS alerts using attack graph analysis. One embodiment predicts multiple ways of penetrating a network to reach critical assets. The set of such paths through the network constitutes an attack graph, which may be aggregated according to underlying network regularities, reducing the complexity of analysis. By knowing the paths of vulnerability through our networks, one may reduce the impact of attacks. IDS sensors may be placed to cover the attack graph, using a minimal number of sensors. This should minimize the cost of sensors, including effort of deploying, configuring, and maintaining them, while maintaining complete coverage of potential attack paths. An embodiment addresses the sensor placement as an instance of the NP-hard minimal set cover problem using an efficient greedy algorithm. Once sensors are deployed and alerts are raised, a predictive attack graph may be used to prioritize alerts based on attack graph distance to critical assets.

An embodiment of the present invention focuses on protecting the network assets that are mission-critical. Embodiments model the network configuration, including topology, connectivity limiting devices such as firewalls, vulnerable services, etc. Additionally, the present invention matches the network configuration to known attacker exploits, simulating attack penetration through the network and predicting attack paths leading to compromise of mission-critical assets. This approach to network attack survivability is called Topological Vulnerability Analysis (TVA). A commercial version of a TVA tool may be acquired through ProInfo, Inc of Bethesda, Md.

The resulting set of attack paths (organized as an attack graph) is a predictive attack roadmap. The TVA attack graph assesses the vulnerability of critical network resources, and automates the traditionally labor-intensive analysis process. TVA also encourages easy “what-if” analyses of candidate network configuration changes, and provides network-hardening recommendations that require minimal changes to the network.

Even after protective measures have been applied across the network, some residual vulnerability usually remains. In such cases, TVA attack graphs may reduce the impact of attacks. The attack graph can guide the placement of IDS sensors across a network to cover known paths of vulnerability. In this way, potentially malicious activity on critical paths may be monitored. Conversely, sensors may not be needed for monitoring traffic that does not lie on critical paths, helping to reduce costs and operator overload. An embodiment of the present invention places sensors to cover attack paths to critical assets, using a minimal number of deployed sensors.

Through the predictive power of TVA attack graphs, an embodiment of the present invention prioritizes IDS alerts based on the level of threat they represent to critical assets. For example, one embodiment gives lower priority to alerts that lie outside critical attack paths. Another embodiment treats particularly severe threats as those seen as coordinated steps where an attacker incrementally advances through the network, especially if only a short distance from mission-critical assets. The attack graph may also provide the context needed for responding to an attack. When an operator has strong evidence (e.g., multiple coordinated steps) of an intrusion, and knows the next network vulnerabilities the attacker could exploit next, the operator can have confidence in taking the appropriate (and highly focused) actions for preventing further penetration.

Because attackers can exploit vulnerabilities as stepping stones to new vantage points, considering network components and vulnerabilities in isolation is clearly insufficient. An embodiment of the current invention implements a comprehensive TVA tool that discovers multi-step attacks, modeling network penetration as real attackers might do. This is a custom tool, written in the Java programming language, with full-featured user interface and attack graph visualization capabilities. Those skilled in the art will recognize that embodiments may created using other languages. In some cases, the implementation may be created using specialized hardware, especially when it embedded in a network traffic device such as router. This TVA tool computes an attack graph showing possible paths through a network. This approach places IDS sensors to cover these predicted TVA paths, and uses this predictive context to prioritize IDS alerts.

In an embodiment of the TVA approach, a network is scanned to catalog hosts, their operating systems, application programs, and vulnerable network services. The TVA approach captures network connectivity, including the effects of connectivity-limiting devices such as firewalls and router access control lists (ACLs). This approach computes the attack graph comprising all known attacks through the network utilizing the resulting network configuration, a database of modeled attacker exploits, and a specification of threat origin and critical network assets.

In particular, from network scans, the TVA tool builds a model of a network configuration. This configuration is then subjected to simulated attacks from a TVA exploit database. Exploits are modeled in terms of preconditions and postconditions. When all preconditions for an exploit are met (e.g., from the initial network state), the exploit is successful, and its postconditions are induced. These postconditions in turn provide potential preconditions for other exploits. The resulting set of exploits, joined by their precondition/postcondition dependencies, forms the attack graph, predicting all possible attacks through the network. An embodiment of the current invention is able to integrate with popular network scanning tools (such as Nessus, available from Tenable Network Security of Columbia, Md.; Retina, available from eEye Digital Security of Irvine, Calif.; and FoundScan, available from FoundStone of Mission Viejo, Calif.) to automate the network model building process. The embodiment may continually monitor sources of reported vulnerabilities, keeping the TVA exploit database current with respect to emerging threats.

TVA attack graphs can follow pre-defined attack scenarios, e.g., based on assumed threat sources (attack starting points) or critical assets to be protected (attack ending points). An embodiment of the present invention constrains the attack graph with respect to these starting and/or ending points. This allows an organization to focus on realistic threat sources, while insuring the safety of critical assets. Algorithmically, these constraints may be applied in two passes. The forward pass traverses the graph in a forward direction from the starting point(s), and the backward pass traverses the graph in a backward direction from the ending point(s). These passes can be applied independently, to constrain the graph in one direction or the other, or combined as a joint constraint.

In their low-level form, TVA attack graphs for realistic sized networks can be large and complex. One embodiment of the present invention aggregates attack graphs at various levels of detail, e.g., host, subnet, etc. An Analysis can then be applied to the appropriate level of graph abstraction, to help keep complexity manageable. In fact, elements of the network model are aggregated in advance, so that attack graph computations are more efficient. The aggregated structures of the present invention may retain all underlying low-level information so that no information is lost compared to the full low-level attack graph. Some embodiments may also make this information is also available for interactive drilldown in attack graph visualization.

Once the TVA attack graph is created, predicting all possible paths through the network, optimal network defenses may then be formulated. A step to reduce risk is to harden the network in advance of attack. Given requirements for mission-critical services, availability of patches, etc., some residual vulnerability paths often remain on a network. Another step is to deploy IDS sensors to monitor traffic and detect potentially malicious activity along these paths.

In one embodiment of the present invention, placement of IDS sensors may be optimized; in the sense that a network's attack graph is covered using a minimal number of sensors. This sensor placement problem is an instance of the classical set cover problem, which is NP-hard. To solve this problem, application of a polynomial-time greedy heuristic, which is known to give good solutions in practice is implemented.

Once sensors are deployed and the IDS starts generating alerts, the attack graphs of an embodiment of the present invention may provide the necessary context for correlating and prioritizing those alerts. For example, if two alerts lie in a sequence along the attack graph, there is strong potential that these are multiple steps along a single attack, and should be taken very seriously. Further, an embodiment of the present invention can predict the minimum number of future steps before the attacker reaches a given critical network asset, and can prioritize the alert accordingly. Based on demonstrated knowledge of possible attack paths, an optimal response for stopping any further progress by the attacker can be formulated.

Attack Graph Generation and Aggregation

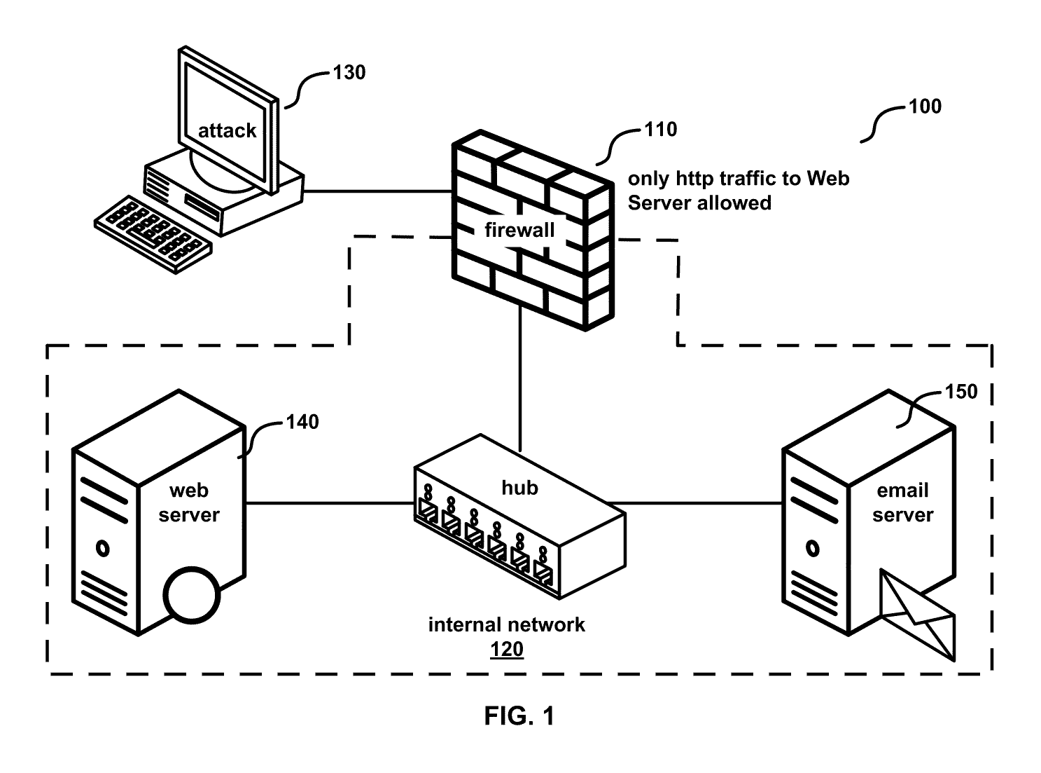

Referring to FIG. 1, as one embodiment, a small network 100 is shown demonstrating the automated generation of attack graphs via a TVA tool. In this network, the purpose of the firewall 110 is to protect the internal network 120 from an outside attack 130. It is configured to allow only hypertext transfer protocol (HTTP) traffic to the internal web server 140, and all other traffic initiated from the outside is blocked. The web server 140 is running a vulnerable version of Microsoft Internet Information Server (IIS), which is reachable from the outside through the firewall 110. The mail server 150 has vulnerable software deployed as well, although the firewall 110 protects it from direct attack from the outside. An issue is whether there are paths that allow the outside attacker 130 to compromise the mail server 150.

In an embodiment of the present invention, the output of the open source Nessus vulnerability scanner may be used to capture the network configuration for FIG. 1. First, scanning from the outside through the firewall 110, targeting the internal network 120 is implemented. Then scanning the internal network 120 behind the firewall is implemented, to see the attacker's options once he gains entry to the internal network 120. Then, the scan results are merged into an overall TVA network model. This model may serve as the initial conditions for a TVA attack simulation, in which a database of simulated exploits derived from Nessus vulnerabilities is applied.

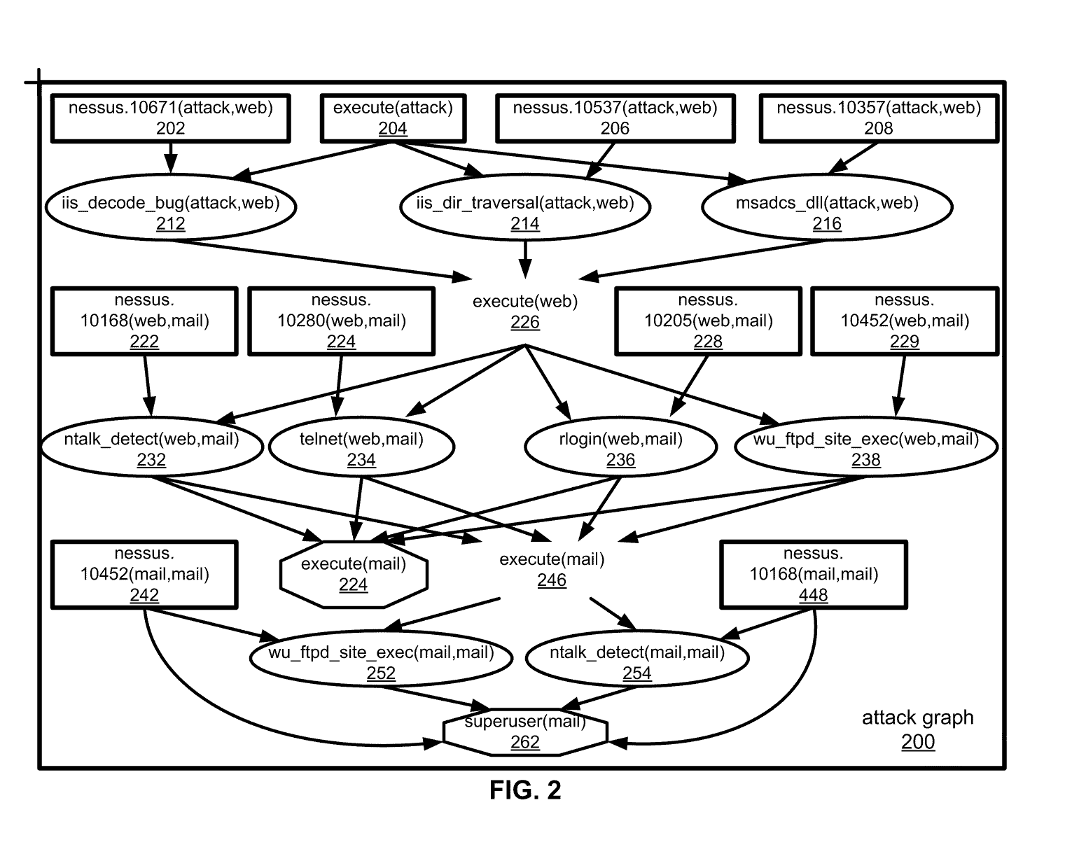

The TVA attack simulation begins on the outside machine 130, and ends with the compromise of the mail server 150. FIG. 2 shows a resulting attack graph 200. Boxes are initial network conditions, and ovals are attacker exploits. Here, a condition of the form nessus.xxxxx(from, to) represents the fact that the from machine can connect to a service on the to machine, and that this service has a particular xxxxx vulnerability detected by Nessus. For example, initial condition nessus.10671(attack, web) 202 means that the web server has Nessus vulnerability number 10671

In FIG. 2, network conditions of the form execute(machine) (204, 226, 246) represent the attacker's ability to execute arbitrary code on a particular machine. The attacker can initially execute code on his own machine, as indicated by the execute(attack) 204 in a box. A condition such as execute(web) 226 is induced as a postcondition of one or more exploits (in this case, by three different exploits), so it does not appear in a box (i.e., not an initial condition). Conditions defined as overall attack goals (in this case, executing code with superuser privilege level on the mail server) are shown in octagons.

The iis_decode_bug(attack, web) 212 exploit in FIG. 2 requires two preconditions to be met, i.e., execute(attack) 204 and nessus.10671(attack, web) 202. Since these are part of the initial network conditions, this exploit is successful, and yields the postcondition execute(web). i.e., the attacker can now execute code on the web server 140. Two other exploits (iis_dir_traversal 214 and msadcs_dll 216) are also possible from the attack machine 130 against the web server 140. Once the attacker can execute code on the web server, four subsequent exploits are possible (232, 234, 236, 238), each from the web server to 140 the mail server 150. Two of those (ntalk_detect 232 and wu_ftpd_site_exec 238) give the ability to execute code as superuser on the mail server 150, i.e., the goal has been reached. The other two (telnet 234 and rlogin 236) give the ability to execute code, but without superuser privilege level. Then two subsequent exploits (wu_ftpd_site_exec 252 and ntalk_detect 254) elevate attacker privilege to superuser on the mail server 150.

The attack graph 200 allows for planning and implementation of network defense strategies. For example, in FIG. 2, removing Nessus vulnerabilities 10671 (202), 10537 (206), and 10357 (208) on the web server 140 would stop the attack. Or, it can be concluded that fixing mail server 150 vulnerabilities 10280 (224) and 10205 (228) are essentially irrelevant hardening options, i.e., 10452 (229) and 10168 (222) would need to be fixed anyway, and together will successfully prevent the attack (assuming it is sufficient to block the attacker from gaining superuser privilege).

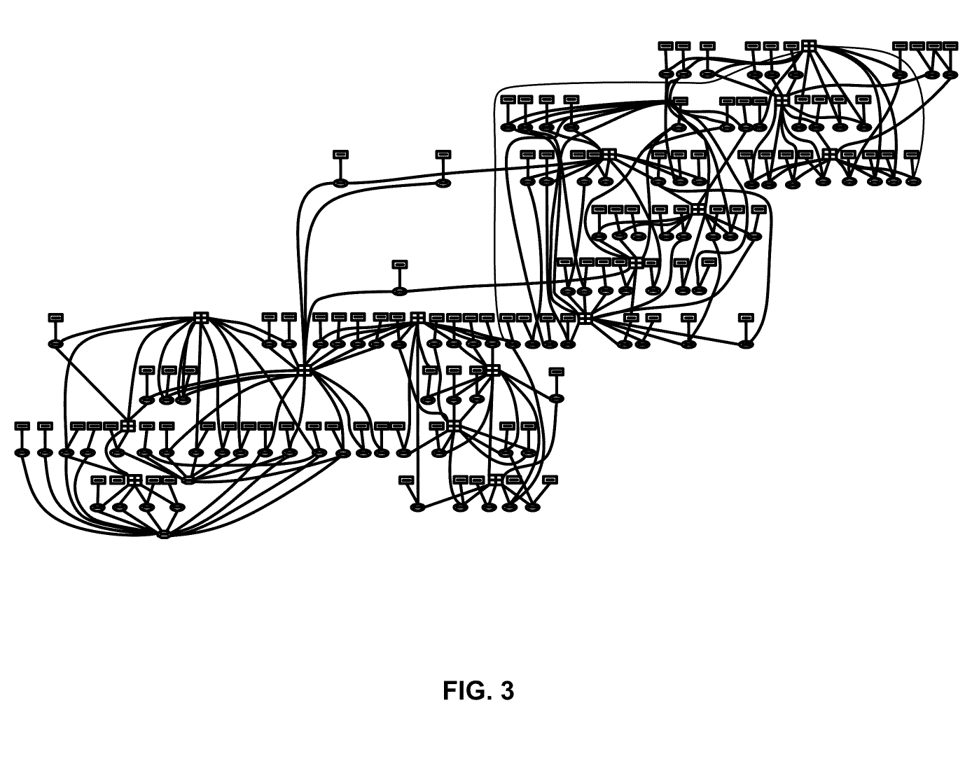

Of course in practice, network attack graphs are usually much more complex than FIG. 2. For example, one embodiment exemplified in FIG. 3 shows an attack graph 300 generated by a TVA tool for an operational network of only 17 machines, across 4 subnets, with between 2 and 6 exploitable vulnerabilities per machine. Despite the complex relationships in this graph, dependency patterns among exploits can still be observed. There are densely connected parts of the graph, connected by relatively sparse sets of edges. These patterns are in fact a consequence of regularities in the network configuration that can be utilized for summarizing attack patterns.

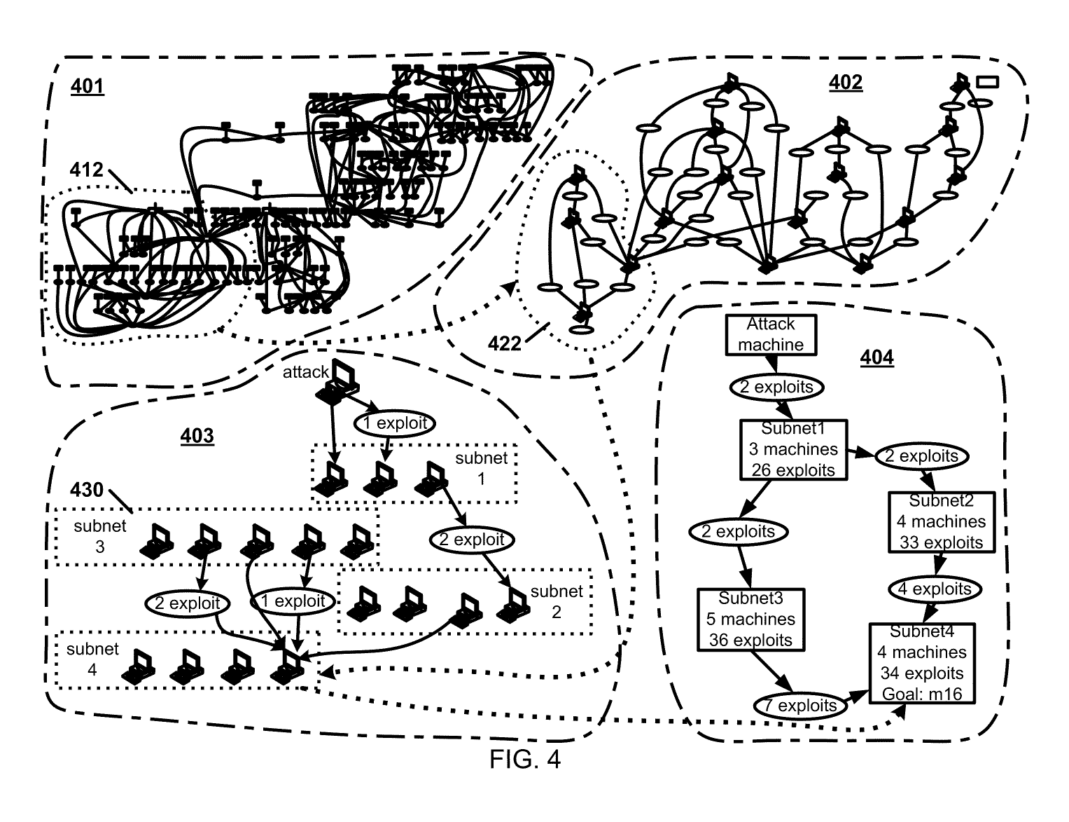

These regularities are a direct reflection of how the network is organized, and are a natural choice for aggregating the attack graph into multiple levels of abstraction. This is illustrated in FIG. 4. As an embodiment, attack graph 401 exemplifies the original attack graph, showing all details. As an embodiment, attack graph 402 exemplifies the graph being aggregated to the level of machines and sets of exploits between them. For example, the circled region 412 contains four machines, with exploit sets between each pair of them. In other words, all the network conditions for a particular machine in attack graph 401 are collapsed to a single “machine” vertex in attack graph 402, and all the exploits between a particular pair of machines (in each direction if applicable) are collapsed to a single machine-to-machine exploit set in attack graph 402. Attack graph 402 thus represents a summary of attack graph 401, providing more of an overview of the attack.

In attack graph 402, the circled portion of the attack graph 422 is fully connected, i.e., this sub-graph forms a clique. This is because these machines are in the same subnet (broadcast domain), so that they have unrestricted access to one another's vulnerable services. This knowledge of the network structure can be incorporated when building the input network model. Within such a fully connected sub-graph, it is sufficient to represent only those exploits to which a machine is vulnerable, since all machines in that sub-graph can exploit those vulnerabilities. Such a set of machines can be called a protection domain, which forms a natural level of aggregation, as shown in attack graph 403. Such a set of machines is called a protection domain, which forms a natural level of aggregation 430, as shown in Fig. attack graph 403. Using this representation, graph size scales linearly within a protection domain (and remains quadratic across domains).

In one embodiment of the present invention, machines can be aggregated in a protection domain to a single graph vertex to reduce analysis complexity even further, as shown in attack graph 404. Machine exploit sets, as shown in attack graph 404 can be aggregated to a single set between each pair of domains. Complexity still scales quadratically, but now as a function of the number of protection domains rather than the number of machines, thus greatly reducing complexity. With this high-level view of the attack graph 404, efficient network defense strategies can be developed. For example, from attack graph 404, it can immediately be concluded that preventing the two exploits into Subnet 1 will prevent the attack. Or, if that is not possible, a second choice is to prevent the two exploits from Subnet 1 to Subnet 2, and the two exploits from Subnet 1 to Subnet 3. Other options are possible, though they involve fixing a greater number of vulnerabilities, and allow deeper penetration by the attacker.

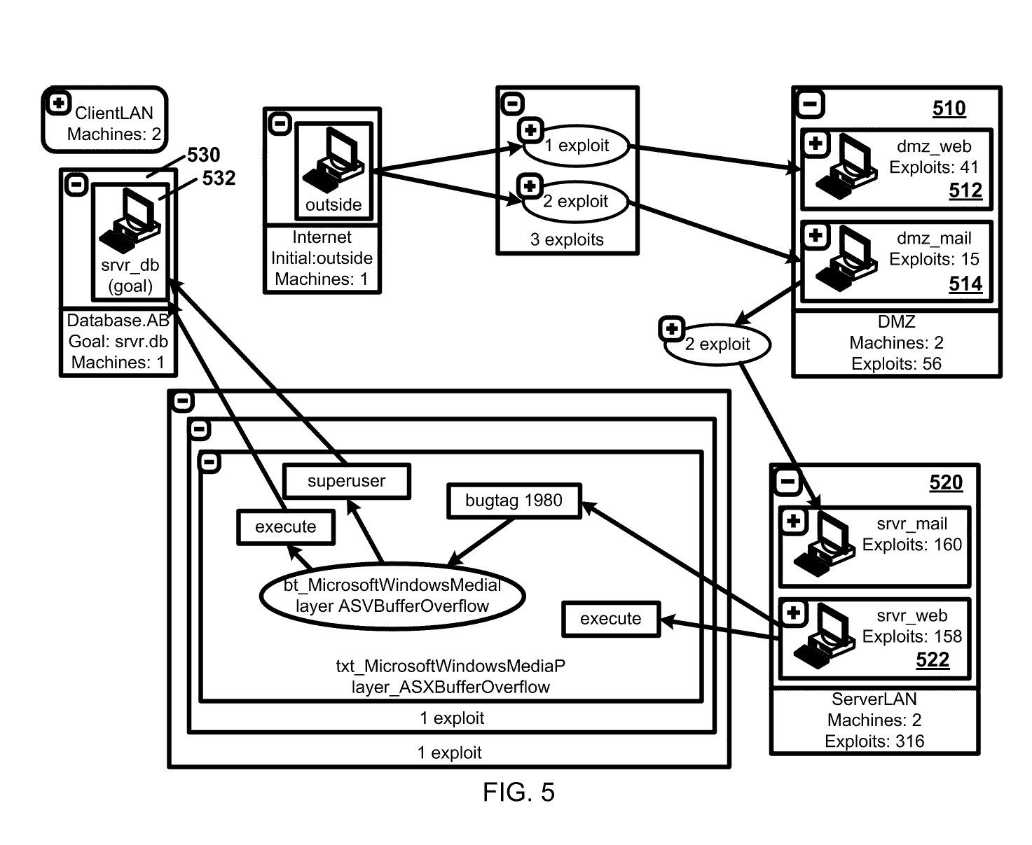

No information is lost in the aggregation of the network model and attack graph. Indeed, it is entirely reversible, so that all the details of the low-level attack graph are available. This is illustrated in FIG. 5, which demonstrates more advanced visualization capabilities of a TVA tool, for an 8-machine testbed network. Here, a variety of levels of detail are shown in a single view of the attack graph. With the interactive visualization capabilities provided by the TVA tool, the analyst can start with a high-level overview of the attack, and drill down as needed for particular attack details.

As an embodiment, FIG. 5, exemplifies a TVA tool having exploits from the outside, to the DMZ web server 512 (one exploit) and to the DMZ mail server 514 (2 exploits). Once inside the DMZ 510, the attacker can exploit the web server 512 in 41 different ways, and exploit the mail server 514 in 15 different ways. Once the DMZ mail server 514 is compromised, the attack can proceed from there to the mail server 514 in the Server LAN 520 (via two different exploits). Inside the Server LAN 520, the mail server 514 can be compromised 160 different ways, and the web server 512 can be compromised 158 ways. Once the Server LAN web server 522 is compromised, the attacker can launch a single exploit against the database server 532 (in the Database LAN 530), which is the defined goal of the attack. The visualization drilldown shows the full details (preconditions and postconditions) for this exploit.

IDS Sensor Placement and Alert Prioritization

At this point, the TVA tool has captured the network configuration, used it to predict all possible paths of vulnerability through the network, and applied hardening measures to help reduce known paths. But because of real-world mission and operational constraints, elimination of all paths is unlikely. The next line of defense is to rely on IDS.

Given the gained knowledge of the network configuration and residual paths of vulnerability, a question arises as to where to place the IDS sensors as to monitor critical paths. Secondly, an analysis of placement will cover critical paths with a minimal number of sensors, to minimize deployment costs. The residual attack graph defines the sources and destinations of traffic to be monitored. Then, sensor locations that cover the critical paths can be identified through analysis of network topology.

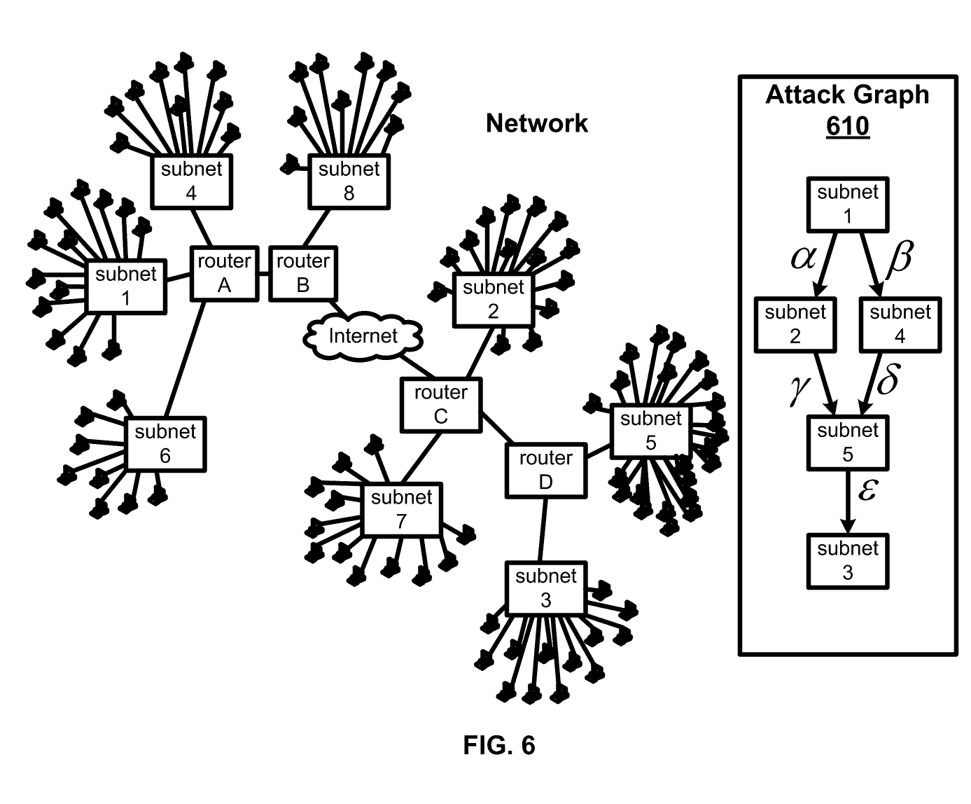

Consider the testbed network in FIG. 6, implemented through a combination of real and replicated machine scans, and simulated network connectivity and firewall effects. There are eight subnets, with 10-20 hosts in each subnet, and routers (and the internet backbone) providing connectivity among the subnets. There are vulnerabilities on many of the network hosts. Though not shown explicitly, the firewalls limit connectivity and help protect the network. Still, vulnerabilities remain on the network, and many are stepping stones, giving new vantage points for further penetration.

The right side of FIG. 6 is an attack graph 610 showing a high-level view of attacks through this network, based on TVA tool results. An assumption can be made that Subnet 3 contains critical network assets to be protected. The attack graph shows all possible paths leading to Subnet 3, at the subnet-to-subnet (protection domain) level. Here, an edge means there is at least one exploit between given protection domains. While other paths may exist through this network, only the ones shown are relevant to the protection of Subnet 3. So it is precisely these paths that need to be monitored by the IDS.

An analysis of network topology for placing sensors to cover all paths may be conducted given the gained knowledge of critical paths through the network. An embodiment of the present invention seeks to cover all critical paths (the attack graph) using the least number of sensors to reduce costs. In set cover, there are given certain sets of elements, and they may have elements in common. The problem is to choose a minimum number of those sets, so that they collectively contain all the elements. In this case, the elements are the edges (between protection domains) of the attack graph, and the sets are potential locations where IDS sensors may be deployed on particular network devices. Each IDS monitors a given set of edges, i.e., can see the traffic between the given attacker/victim machines.

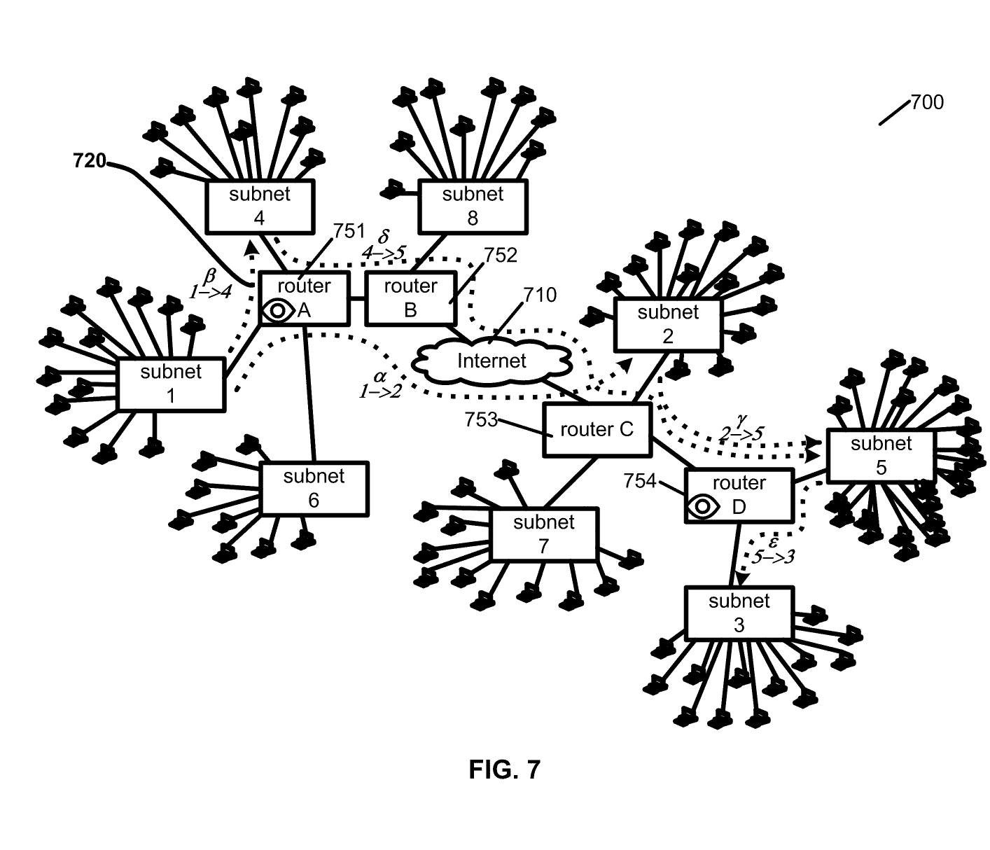

Consider FIG. 7, which builds from the testbed network in FIG. 6. Here, through the network topology 700, tracing the routes of each subnet-to-subnet edge of the attack graph can be achieved. For example, the vulnerable paths from Subnet 1 to Subnet 2 is shown as 710, from Subnet 1 to Subnet 4 as 720, etc. The problem is then the selection of a minimum set of routers (sensors) that covers all the vulnerable paths in the attack graph.

Set cover is known to be computationally hard, one of Karp's original 21 NP-complete problems. Fortunately, there is a well known polynomial-time greedy algorithm for set cover that gives good results in practice. The greedy algorithm for set covering follows this rule: at each stage, choose the set that contains the largest number of uncovered elements.

In this case, each router (751-754) can see traffic for a subset of the entire attack graph, i.e., each router covers certain attack graph edges. The problem is then to choose a minimum set of routers that cover all edges. From FIG. 7, the following information can be derived:

Router A (751) covers {(1,2), (1,4), (4,5)}={α,β, δ}

Router B (752) covers {(1,2), (4,5)}=={α, δ}

Router C (753) covers {(1,2), (4,5), (2,5)}=={α, δ, γ}

Router D (754) covers {(2,5), (4,5), (5,3)}=={γ, δ, ε}

Here, the element (x, y) means an attack graph edge set from Subnet x to Subnet y.

An embodiment of the present invention refines the greedy algorithm to favor large sets that contain infrequent elements. In this example, Router A 751 is a large set (three elements) with the infrequent element β=(1,4), thus it is chosen first. In the next iteration, Router D 754 is chosen, which has the largest number of uncovered elements, i.e., γ=(2,5) and ε=(5,3). At this point, all five elements (edges in the attack graph) have been covered. The sensor-placement solution is thus complete. Shown in FIG. 7 are optimal sensor locations for Router A 751 and Router D 754.

In this instance, the actual optimal solution has been developed. In general, the greedy algorithm approximates the optimal solution within a factor of ln(n), for n elements to be covered, though in practice it usually does much better than this. In this case, n is the number of attack graph edges, aggregated by protection domains, which is usually much smaller than the number of edges between individual machines. The greedy algorithm has been shown to be essentially the best possible polynomial-time approximation algorithm for general set cover. However, for restricted cases in which each element (per-domain edge) occurs in at most f sets (routers), a polynomial-time solution is possible that approximates the optimum to within a factor of f.

Using appropriate data structures, the greedy algorithm for set cover can be implemented in O(n), where n is again the number of per-domain attack graph edges. More nearly optimal solutions for set cover may be possible through more sophisticated algorithms, with longer run times, such as simulated annealing and evolutionary algorithms. Set cover (and its dual the hitting set problem) is a well-studied problem in computer science.

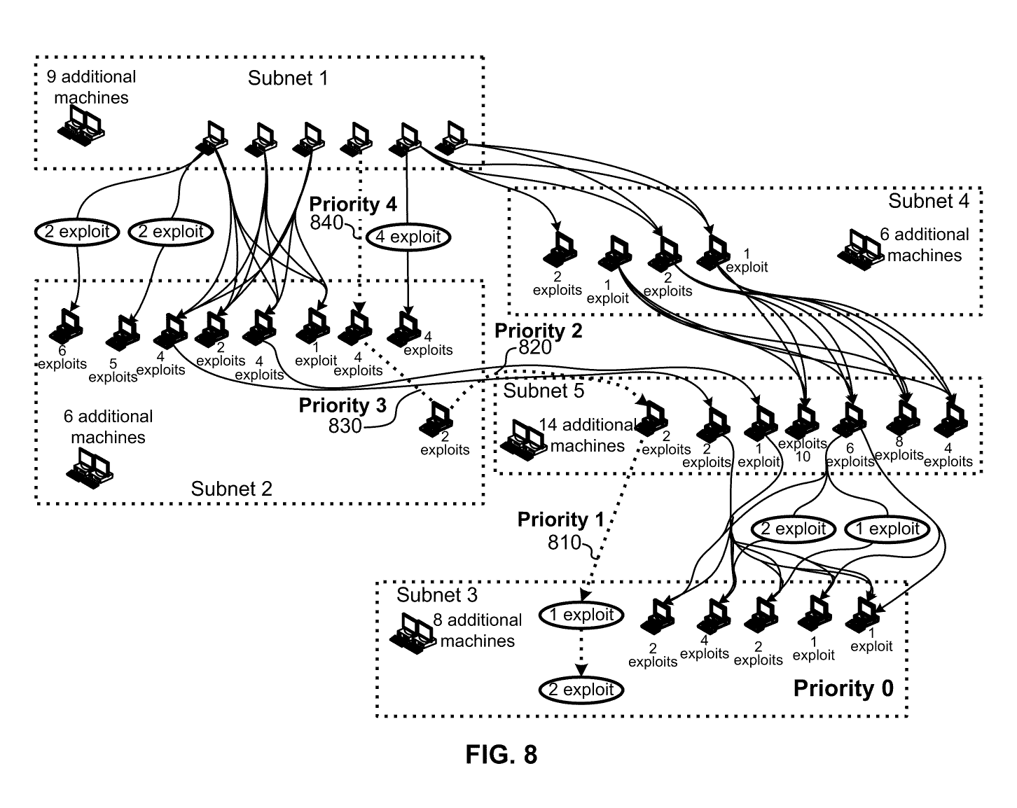

Once IDS sensors are in place and alerts are generated, the attack graph can be used to correlate alerts, prioritize them, predict future attack steps, and respond optimally. FIG. 8 shows attack graph 800 details for the testbed network in FIG. 6, where each graph edge is a set of exploited vulnerabilities from one machine to another. Within each subnet (the shaded regions in the figure), the machines have unrestricted access to one another's vulnerabilities. Paths in the graph all lead to the assumed critical network assets (shown in the figure as crowns).

In an embodiment of the present invention, alerts can be prioritized based on attack graph distance to critical assets. That is, attacks closer to a critical asset may be given higher priority, since they represent a greater risk. At any point that an attack is detected, the attack graph may be used to predict next possible steps, and take specific actions such as blocking specific source/destination machines and destination port.

As an example operational scenario, in FIG. 8, assume that a security operator sees the Priority-4 840 IDS alarm. From the attack graph, the security operator knows that this potential attack is still at least three steps away from mission-critical machines. Because of the possibility of a false alarm, the operator might delay taking action initially. Then, if the security operator sees the Priority-3 830 alarm (one step closer to a critical machine), the attack graph shows that this is an immediate next possible step, providing further evidence that this is a real attack (versus a false alarm). If the operator still delays action (e.g., after detail drilldown yields no conclusive result), a subsequent Priority-2 820 alarm (now only one step away from the critical machine) might then cause the security operator to respond. The attack graph shows exactly which source/destination machines and ports the operator should block to prevent attacker access to the critical machine, while avoiding disruption of other potentially mission-critical network services. An embodiment of the present invention provides this kind of highly focused attack response capability provided by the predictive TVA attack graphs coupled with deployed IDS sensors.

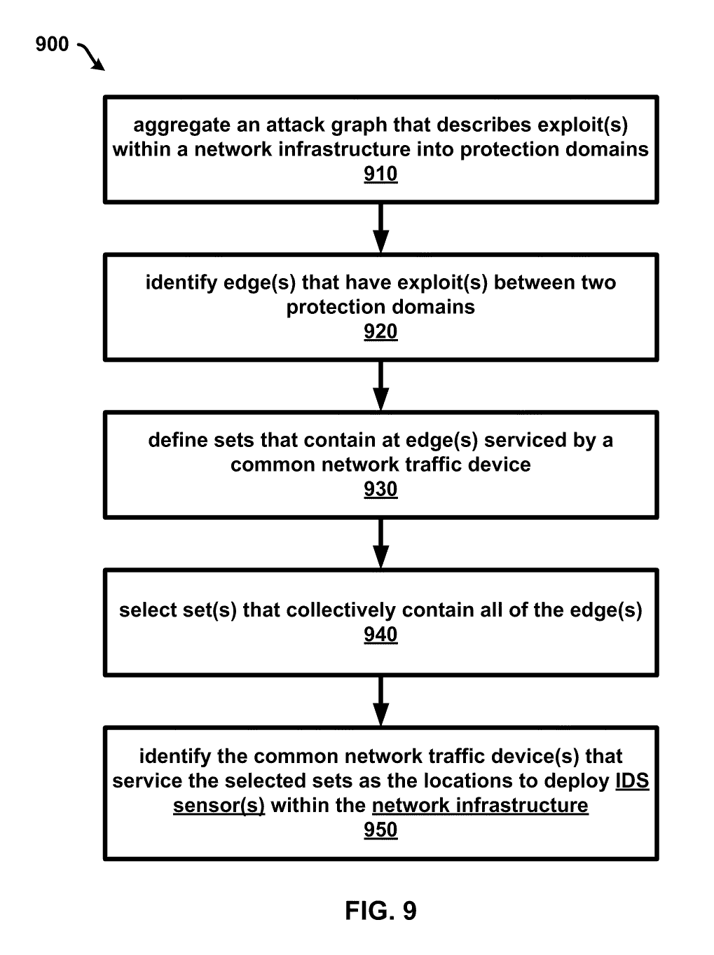

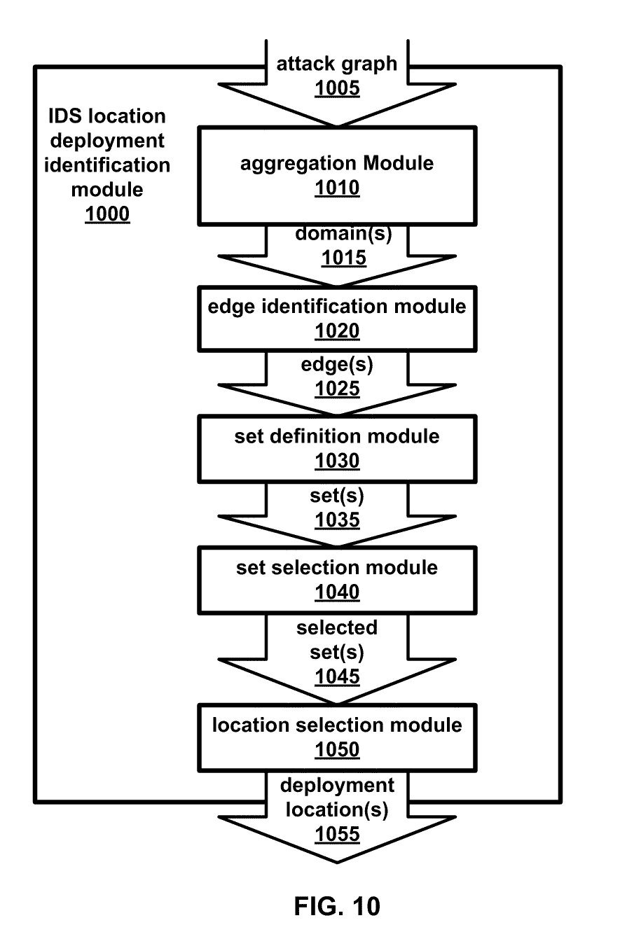

FIGS. 9 and 10 summarize potential embodiments of the invention. An embodiment of the present invention, as exemplified in FIG. 9, is a computer readable storage medium that contains instructions that when executed by at least one processor, causes the processor(s) to perform a method 900 for identifying locations to deploy IDS sensor(s) within a network infrastructure.

The method 900 for identifying locations to deploy IDS sensor(s) within a network may comprise aggregating an attack graph that describes exploit(s) within a network infrastructure into protection domains 910. The attack graph may be configured to describe exploit(s) in at least a part of the network infrastructure. Further, the embodiment may include identifying edge(s) that have exploit(s) between two protection domains 920, defining sets that contain edge(s) serviced by a common network traffic device 930, selecting set(s) that collectively contain all of the edge(s) 940, and identifying the common network traffic device(s) that service the selected sets as the locations to deploy IDS sensor(s) within the network infrastructure 950.

In an embodiment of the present invention, the selecting set(s) that collectively contain all of the edge(s) 940 may further include selecting set(s) that cover critical path(s) through the network infrastructure that lead to a critical asset. The set selection method 940 may further include selecting set(s) that cover critical path(s) through the network infrastructure that starts at an assumed threat source. Further variations of this embodiment may allow the set selection method 940 to include selecting a minimal number of sensors necessary to cover critical path(s) through the network infrastructure. The set selection method 940 may also further include utilizing a greedy algorithm. The greedy algorithm favors large sets that contain edge(s) that are infrequently used. Frequency is the number of times an edge appears across all sets

In an embodiment of the present invention, the method 900 for identifying locations to deploy on IDS sensor(s) within a network may further include prioritizing alerts from IDS sensors deployed within the network infrastructure using at least one attack graph distance to at least one critical asset. Attack graph distance may be measured in multiple ways such as: 1) the number of edges that are traversed to reach critical asset; 2) the number of protection domains crossed; and 3) the number of network traffic devices.

An embodiment of the present invention is an IDS location deployment identification module 1000 as exemplified in FIG. 10. The IDS location deployment identification module 1000 may include an attack graph aggregation module 1010, an edge identification module 1020, a set definition module 1030, a set selection module 1040 and an IDS sensor location module 1050. The IDS location deployment identification module 1000 identifies locations to deploy at least one IDS sensor within a network infrastructure. Further variations of this embodiment may be stored on a computer readable storage medium that contains instructions that when executed by at least one processor, causes the at least one processor to perform a method for identifying locations to deploy IDS sensor(s) within a network infrastructure. A network infrastructure may include a group of interconnected computing devices and/or processors. Such computing devices and/or processors may be part of special purpose network traffic flow devices such as routers, switches, hubs, repeaters, and bridges. The network infrastructure may include personal area, local area, campus area, metropolitan area, wide area, global area, and virtual private area networks. IDS location deployment identification module 1000 further prioritizes alerts from IDS sensors deployed within the network infrastructure using at least one attack graph distance to at least one critical asset.

In an embodiment of the present invention, the attack graph aggregation module 1010 may be configured to aggregate an attack graph into at least two protection domains. The attack graph preferably describes exploit(s) in at least a part of a network infrastructure.

In an embodiment of the present invention, the edge identification module 1020 may be configured to identify edge(s) having exploit(s) between two of the protection domains.

In an embodiment of the present invention, the set definition module 1030 may be configured to define set(s) containing edge(s) serviced by a common network traffic device;

In an embodiment of the present invention, the set selection module 1040 may be configured to select set(s) that collectively contain edge(s). The set selection module 1040 may further be configured to select set(s) that cover critical path(s) through the network infrastructure that lead to critical asset(s). The set selection module 1040 may further be configured to select set(s) that cover critical path(s) through the network infrastructure that start at an assumed threat source. Further variations of this embodiment may allow the set selection module 1040 to be configured to select a minimal number of sensors necessary to cover critical path(s) through the network infrastructure. The set selection module 1040 may also be further configured to use a greedy algorithm. The greedy algorithm favors large sets that contain edge(s) that are infrequently used.

In an embodiment of the present invention the IDS sensor location module 1050 may be configured to identify the common network traffic device that services the selected sets as the locations to deploy the at least one IDS sensor within the network infrastructure.

In an embodiment of the present invention, the IDS location deployment identification module 1000 may further be configured to include prioritizing alerts from IDS sensors deployed within the network infrastructure using at least one attack graph distance to at least one critical asset.

In this specification, “a” and “an” and similar phrases are to be interpreted as “at least one” and “one or more.”

In addition, it should be understood that any figures which highlight the functionality and advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A computer readable storage medium that contains instructions that when executed by at least one processor, causes the at least one processor to perform a method for identifying locations to deploy at least one IDS sensor within a network infrastructure, the method comprising
a) aggregating an attack graph into at least two protection domains, the attack graph describing at least one exploit in at least a part of the network infrastructure;
b) identifying at least one edge, each of said “at least one edge” having at least one of the at least one exploit between two of the at least two protection domains;
c) define at least two sets, each set containing at least one of the at least one edge, all of the at least one of the at least one edge serviced by a common network traffic device;
d) selecting at least one of the at least two sets that collectively contain all of the at least one edge;
e) identifying the common network traffic device that services the selected sets as the locations to deploy the at least one IDS sensor within the network infrastructure.

2. The medium according to claim 1, wherein the selecting includes at least one of the at least two sets that cover at least one critical path through the network infrastructure that leads to a critical asset.

3. The medium according to claim 1, wherein the selecting includes at least one of the at least two sets that cover at least one critical path through the network infrastructure that starts at an assumed threat source.

4. The medium according to claim 1, wherein the selecting selects the fewest number of sensors necessary to cover at least one critical path through the network infrastructure.

5. The medium according to claim 1, further including using the selected sets to plan an attack response.

6. The medium according to claim 1, wherein the selecting uses a greedy algorithm.

7. The medium according to claim 6, wherein greedy algorithm favors large sets that contain at least one of the at least one edge that is infrequently used.

8. The medium according to claim 1, wherein the protection domain encompasses at least part of a subnet.

9. The medium according to claim 1, further including prioritizing alerts from IDS sensors deployed within the network infrastructure using at least one attack graph distance to at least one critical asset.

10. The medium according to claim 1, further including prioritizing alerts from IDS sensors deployed within the network infrastructure using at least one predictive attack response.

11. A IDS location deployment identification module comprising
a) an attack graph aggregation module configured to aggregate an attack graph into at least two protection domains, the attack graph describing at least one exploit in at least a part of a network infrastructure;
b) an edge identification module configured to identify at least one edge, each of the at least one edge having at least one of the at least one exploit between two of the at least two protection domains;
c) a set definition module configured to define at least two sets, each set containing at least one of the at least one edge, all of the at least one of the at least one edge serviced by a common network traffic device;
d) a set selection module configured to select at least one of the at least two sets that collectively contain all of the at least one edge; and
e) an IDS sensor location module configured to identify the common network traffic device that services the selected sets as the locations to deploy the at least one IDS sensor within the network infrastructure.

12. The module according to claim 11, wherein the set selection module is further configured to select at least one of the at least two sets that cover at least one critical path through the network infrastructure that leads to a critical asset.

13. The module according to claim 11, wherein the set selection module is further configured to select at least one of the at least two sets that cover at least one critical path through the network infrastructure that starts at an assumed threat source.

14. The module according to claim 11, wherein the set selection module is further configured to select the fewest number of sensors necessary to cover at least one critical path through the network infrastructure.

15. The module according to claim 11, further including a response module configured to use the selected sets to plan an attack response.

16. The module according to claim 11, wherein the set selection module is further configured to use a greedy algorithm.

17. The module according to claim 16, wherein greedy algorithm favors large sets that contain at least one of the at least one edge that is infrequently used.

18. The module according to claim 11, wherein protection domain encompasses at least part of a subnet.

19. The module according to claim 11, further a prioritization module configured to prioritize alerts from IDS sensors deployed within the network infrastructure using at least one attack graph distance to at least one critical asset.

20. The module according to claim 11, further including a prioritization module configured to prioritize alerts from IDS sensors deployed within the network infrastructure using at least one predictive attack response.
